(19) United States
(12) Patent Application Publication
(10) Pub. No.: US 2022/0098527 A1
(43) Pub. Date: Mar. 31, 2022

(54) AN EXTRUDED SOAP BAR WITH HIGH WATER CONTENT

(71) Applicant: Conopco, Inc., d/b/a UNILEVER, Englewood Cliffs, NJ (US)

(72) Inventors: Ajit Manohar AGARKHED, Thane (IN); Amalendu BANGAL, Dist-Paschim Midnapore (IN); Sudipta GHOSH DASTIDAR, Bangalore (IN); Swapnil Ravikant HEGISHTE, Mumbai (IN); Shailendra PRATAP, Bangalore (IN); Yuriy Konstantinovich YAROVOY, Monroe, CT (US)

(73) Assignee: Conopco, Inc., d/b/a UNILEVER, Englewood Cliffs, NJ (US)

(21) Appl. No.: 17/425,349

(22) PCT Filed: Feb. 11, 2020
(86) PCT No.: PCT/EP2020/053443

§ 371 Date: Jul. 23, 2021

(30) Foreign Application Priority Data
Feb. 19, 2019 (EP) 19157897.0

(51) Int. Cl. C11D 9/02; C11D 9/18; C11D 9/12; C11D 9/26; C11D 13/18; C11D 17/00

(52) U.S. Cl. CPC C11D 9/02; C11D 9/18; C11D 17/0065; C11D 9/26; C11D 13/18; C11D 9/12

(57) ABSTRACT

The present invention relates to an extruded soap bar composition. It more particularly relates to a soap bar composition which comprises low amount of soap where high amount of water can be incorporated. This is achieved by including selective amount of zeolite therein. The soap bars of the invention are easy to extrude and stamp.

### FIELD OF THE INVENTION

The present invention relates to an extruded soap bar composition. It more particularly relates to a soap bar composition that comprises high amount of water and yet is easy to extrude and stamp.

### BACKGROUND OF THE INVENTION

Surfactants have been used for personal wash applications for a long time. There are many category of products in the personal wash market e.g. body wash, face wash, hand wash, soap bars, shampoos etc. Products which are marketed as body wash, face wash and shampoos are generally in liquid form and are made of synthetic anionic surfactants. They are generally sold in plastic bottles/containers. Soap bars and hand wash products generally contain soaps. Soap bars do not need to be sold in plastic containers and are able to retain their own shape by virtue of being structured in the form of a rigid solid. Soaps bars are usually sold in cartons made of cardboard.

Soap bars are generally prepared through one of two routes. One is called the cast bar route while the other is called the milled and plodded route (also known as extrusion route). The cast bar route has inherently been very amenable in preparing low TFM (total fatty matter) bars. Total fatty matter is a common way of defining the quality of soap. TFM is defined as the total amount of fatty matter, mostly fatty acids, that can be separated from a sample of soap after splitting with a mineral acid, usually hydrochloric acid. In the cast bar soaps, the soap mixture is mixed with polyhydric alcohols and poured in casts and allowed to cool and then the soap bars are removed from the casts. The cast bar route enables production at relatively lower throughput rates.

In the milled and plodded route, the soap is prepared with high water content and then spray dried to reduce the moisture content and to cool the soap after which other ingredients are added and then the soap is extruded through a plodder and optionally cut and stamped to prepare the final soap bar. The milled and plodded soaps generally have a high TFM in the range of 60 to 80 weight percent.

Milled and plodded soap bars are also known as extruded soap bars. They are composed of very many different types of soaps. Most soap compositions comprise both water insoluble as well as water soluble soaps. Their structure is generally characterized by a brick and mortar type structure. Insoluble soaps (called bricks) usually consist of higher chain C16 and C18 soaps (palmitate and stearate soap). They are generally included in soap bars to provide structuring benefits i.e they provide shape to the bars. Soap bars also consist of water soluble soaps (which act as the mortar) which are generally unsaturated C18:1 and 18:2 sodium soap (oleate soap) in combination with short chain fatty acids (generally C8 to C12 or even up to C14 soap). Water soluble soaps generally aid in cleaning.

In addition to about the 60-80 wt % TFM, soap bars presently prepared through the extruded route for personal wash contain about 14-22 wt % water. There is a need for developing sustainable technologies where one approach is to develop soaps with lower TFM content and by increasing the water content with no compromise on the cleaning efficacy. The present inventors are aware of various attempts by the present applicants and others to reduce the fatty matter content. These technologies include approaches to structure soap bars, like inclusion of aluminium phosphate or in situ generation of calcium silicate. Such technologies are useful for preparing bars for laundering application but such materials are not very skin friendly and so are not appropriate for personal washing. If one simply substitutes the TFM with higher amount of water, it causes problems during extrusion of the soap mass and further the extruded bars are sticky and cannot be stamped easily. The present inventors are also aware of various other approaches including inclusion of natural aluminosilicate clays like bentonite or kaolinite but they are found to not be very efficient in structuring the bars at low amounts.

U.S. Pat. No. 4,678,593 (P&G, 1987) discloses transparent or translucent toilet compositions in a bar form incorporating a smectite type clay. The compositions are preferably milled toilet bars and demonstrate improved skin conditioning performance on oily skin types together with excellent bar appearance. However, the present inventors found that this technology cannot be used to reduce TFM to a preferred range as low as 40 to 60 wt %.

The present inventors found that inclusion of zeolites in a very specified ranges in a soap bar with very specific low TFM range is able to provide soap bars with high moisture content that is easy to extrude and stamp as well as have all the sensory and bar integrity properties on storage and use.

It is thus an object of the present invention to provide for a low TFM soap bar which can be prepared using the extrusion route and is easily and conveniently stampable.

It is another object of the present invention to provide for a low TFM soap bar which in addition to being conveniently extrudable and stampable does not compromise on the bar integrity or sensorial properties.

### SUMMARY OF THE INVENTION

The present invention relates to an extruded soap bar comprising

(i) 40 to 75 wt % soap;
(ii) 3 to 20 wt % zeolite and
(iii) 22 to 35 wt % water.

Another aspect of the present invention relates to a process to prepare the soap bar of the invention comprising the step of including substantially all of the zeolite during the step of saponification to form the soap.

### DETAILED DESCRIPTION OF THE INVENTION

These and other aspects, features and advantages will become apparent to those of ordinary skill in the art from a reading of the following detailed description and the appended claims. For the avoidance of doubt, any feature of one aspect of the present invention may be utilized in any other aspect of the invention. The word “comprising” is intended to mean “including” but not necessarily “consisting of” or “composed of.” In other words, the listed steps or options need not be exhaustive. It is noted that the examples given in the description below are intended to clarify the invention and are not intended to limit the invention to those examples per se. Similarly, all percentages are weight/weight percentages unless otherwise indicated. Except in the operating and comparative examples, or where otherwise explicitly indicated, all numbers in this description and claims indicating amounts of material or conditions of reaction, physical properties of materials and/or use are to be understood as modified by the word “about”. Numerical ranges expressed in the format “from x to y” are understood to include x and y. When for a specific feature multiple preferred ranges are described in the format “from x to y”, it is understood that all ranges combining the different endpoints are also contemplated.

The present invention relates to a soap bar composition. By a soap bar composition is meant a cleansing composition comprising soap which is in the form of a shaped solid. The soap bar of the invention is especially useful for personal cleansing. The soap bar of the present invention comprises 40 to 75% total amount of soap, preferably 40 to 60 wt % soap. The term soap means salt of fatty acid. Preferably, the soap is soap of C8 to C24 fatty acids.

The cation may be an alkali metal, alkaline earth metal or ammonium ion, preferably alkali metals. Preferably, the cation is selected from sodium or potassium, more preferably sodium. The soap may be saturated or unsaturated. Saturated soaps are preferred over unsaturated soaps for stability. The oil or fatty acids may be of vegetable or animal origin.

The soap may be obtained by saponification of oils, fats or fatty acids. The fats or oils generally used to make soap bars may be selected from tallow, tallow stearins, palm oil, palm stearins, soya bean oil, fish oil, castor oil, rice bran oil, sunflower oil, coconut oil, babassu oil, and palm kernel oil. The fatty acids may be from coconut, rice bran, groundnut, tallow, palm, palm kernel, cotton seed or soyabean.

The fatty acid soaps may also be synthetically prepared (e.g. by the oxidation of petroleum or by the hydrogenation of carbon monoxide by the Fischer-Tropsch process). Resin acids, such as those present in tall oil, may also be used. Naphthenic acids may also be used.

The soap bar may additionally comprise synthetic surfactants selected from one or more from the class of anionic, non-ionic, cationic or zwitterionic surfactants, preferably from anionic surfactants. These synthetic surfactants, as per the present invention, are included in less then 8%, preferably less then 4%, more preferably less then 1% and sometimes absent from the composition.

The composition of the present invention is in the form of a shaped solid for example a bar. The cleaning soap composition is a wash off product that generally has sufficient amount of surfactants included therein that it is used for cleansing the desired topical surface e.g. the whole body, the hair and scalp or the face. It is applied on the topical surface and left thereon only for a few seconds or minutes and washed off thereafter with copious amounts of water.

The soap bars of the present invention preferably includes low molecular weight soaps (C8 to C14 soaps) which are generally water soluble, which are in the range of 2 to 20% by weight of the composition. It is preferred that the soap bar includes 15 to 55 wt % of the soap of C16 to C24 fatty acid, which are generally water insoluble soaps. Unsaturated fatty acid soaps preferably at 15 to 35% may also be included in the total soap content of the composition. Unsaturated soaps are preferably oleic acid soaps.

The composition of the invention comprises selective amount of zeolite which is in the range of 3 to 20%, preferably 5 to 15% by weight of the composition. Zeolites are hydrated aluminosilicates. Their structure consists in a three dimensional framework of interlinked tetrahydra of AlO₄ and SiO₄ coordinated by oxygen atoms. Zeolites are solids with a relatively open, three-dimensional crystal structure built from the elements aluminum, oxygen, and silicon, with alkali or alkaline-earth metals (such as sodium, potassium, or magnesium) with water molecules trapped in the gaps between them. Zeolites form with many different crystalline structures, which have large open pores (sometimes referred to as cavities) in a very regular arrangement and roughly the same size as small molecules.

The structural formula of zeolite based on its crystal unit cell (assuming both the SiO₂ and AlO₂ as variables) can be represented by

M_{a/n}(AlO₂)ₐ(SiO₂)_{b}.wH₂O

Where M is the cation (e.g sodium, potassium or magnesium), w is the number of water molecules per unit cell, and a and b are total number of tetrahedra of Al and Si, respectively per unit cell; and n is valency of the metal ion. The ratio of b/a usually varies from 1 to 5.

E.g. for Mordenite the chemical formula is Na₈ (AlO₂)₈ (SiO₂)₄₀

Where a=8 and b=40; b/a is 5.

For Zeolite 4A, the chemical formula is Na₉₆ (AlO₂)₉₆ (SiO₂)₉₆

Where a=96 and b=96; b/a is 1.

Some zeolites have b/a value which vary from 10 to 100 or even higher e.g. for ZSM-5 type of zeolite.

As per this invention zeolites which are preferred for use in the soap composition include Zeolite 4A, Zeolite 5A, Zeolite 13A or Zeolite 3A. The most preferred Zeolite is Zeolite 4A.

The soap bar composition of the invention may additionally comprise a second particulate active in addition to zeolite that helps improve the water structuring capability and thereby the hardness viz. magnesium carbonate. When used, magnesium carbonate is included in 0.1 to 7% by weight of the soap bar composition. The inventors have tried similar particulate active in place of magnesium carbonate like talc, bentonite and kaolinite and found that they do not work as well as magnesium carbonate. As an especially preferred aspect of the present invention, magnesium carbonate may replace a part of the zeolite that could have been used and one would still get good water structuring. This would deliver some cost advantage. However, it is not possible to replace all of the zeolite with magnesium carbonate. When the combination of zeolite and magnesium carbonate is used, the weight ratio of zeolite to magnesium carbonate is preferably in the range of 5:1 to 1:5.

The soap bar of the invention is capable of stably retaining high amount of water as compared to conventional soap bar. The amount of water in the soap composition ranges from 22 to 35%, preferably 25 to 32% by weight of the composition. Without wishing to be bound by theory, the inventors believe that the zeolite in the soap framework adsorb high amount of water reversibly. The amount of water adsorbed by the zeolite may reach 30% by weight of the dry zeolite without any volume modification. Further, the inventors believe that if the zeolite is included in the saponification stage the zeolite is more uniformly distributed in the soap matrix and also adsorbs water easier and faster such that the dynamic balance of water content over severe temperature and humidity cycles on storage of the soap, is better maintained thus leading to a more stable soap bar that does not dry fast nor does it exhibit other problems like cracking or efflorescence.

The soaps bar composition may optionally comprise 2 to 15%, preferably 4 to 12% by weight of free fatty acids. By free fatty acids is meant a carboxylic acid comprising a hydrocarbon chain and a terminal carboxyl group bonded to an H. Suitable fatty acids are C8 to C22 fatty acids. Preferred fatty acids are C12 to C18, preferably predominantly saturated, straight-chain fatty acids. However, some unsaturated fatty acids can also be employed.

The composition preferably comprises a polyhydric alcohol (also called polyol) or mixture of polyols. Polyol is a term used herein to designate a compound having multiple hydroxyl groups (at least two, preferably at least three) which is highly water soluble. Many types of polyols are available including: relatively low molecular weight short chain polyhydroxy compounds such as glycerol and propylene glycol; sugars such as sorbitol, manitol, sucrose and glucose; modified carbohydrates such as hydrolyzed starch, dextrin and maltodextrin, and polymeric synthetic polyols such as polyalkylene glycols, for example polyoxyethylene glycol (PEG) and polyoxypropylene glycol (PPG). Especially preferred polyols are glycerol, sorbitol and their mixtures. Most preferred polyol is glycerol. In a preferred embodiment, the bars of the invention comprise 0 to 8%, preferably 1 to 7.5% by wt. polyol.

The soap bar composition generally comprises electrolyte and water. Electrolytes as per this invention include compounds that substantially dissociate into ions in water. Electrolytes as per this invention are not an ionic surfactant. Suitable electrolytes for inclusion in the soap making process are alkali metal salts. Preferred alkali metal salts include sodium sulfate, sodium chloride, sodium acetate, sodium citrate, potassium chloride, potassium sulfate, sodium carbonate and other mono or di or tri salts of alkaline earth metals, more preferred electrolytes are sodium chloride, sodium sulfate, sodium citrate, potassium chloride and especially preferred electrolyte is sodium chloride sodium sulphate, sodium citrate or a combination thereof. For the avoidance of doubt, it is clarified that the electrolyte is a non-soap material. Electrolyte is preferably included in 0.1 to 6%, more preferably 0.5 to 6%, even more preferably 0.5 to 5%, furthermore preferably 0.5 to 3%, and most preferably 1 to 3% by weight of the composition. It is preferred that the electrolyte is included in the soap bar during the step of saponification to form the soap.

The soap composition may be made into a bar by a process that first involves saponification of the fat charge with alkali followed by extruding the mixture in a conventional plodder. The plodded mass may then be optionally cut to a desired size and stamped with a desirable indicia. An especially important benefit of the present invention is that, notwithstanding the high amount of water content of the soap bar, compositions thus prepared by extrusion are found to be easy to stamp with a desirable indicia. The bar is preferably easy to extrude. By “easy to extrude” is meant that the hardness of the bar as it is extruded is high enough that it exits the extruder in a firm enough form that it can be called a rigid bar. The hardness of the bar is preferably higher than 1.2 kg, more preferably in the range of 1.2 to 5.0 kg (at 40° C.). The hardness is preferably measured using the TA-XT Express apparatus available from Stable Micro Systems. The hardness is measured using this apparatus with a 30° conical probe—Part #P/30c to a penetration of 15 mm. If the soap mass is too soft and is passed through the extruder it will not extrude out of the extruder in a cohesive enough mass to be called a bar. The bar is preferably easy to stamp. By “easy to stamp” is meant that the soap bar is of such a consistency and low enough stickiness that it does not stick to the die that is used to stamp any desired idicia on the bar. The soap bar prepared by the process of the invention therefore preferably comprises an indicium stamped thereupon.

A preferred process involves including substantially all of the zeolite during the step of saponification to form the soap. By “substantially all of the zeolite” is meant more than 50 wt %, preferably more than 70 wt %, further more preferably more than 90 wt %, even further more preferably more than 95 wt % and ideally all of the zeolite.

The various optional ingredients that make up the final soap bar composition are as described below:

### Organic and Inorganic Adjuvant Materials

The total level of the adjuvant materials used in the bar composition should be in an amount not higher than 50%, preferably 1 to 50%, more preferably 3 to 45% by wt. of the soap bar composition.

Suitable starchy materials which may be used include natural starch (from corn, wheat, rice, potato, tapioca and the like), pregelatinzed starch, various physically and chemically modified starch and mixtures thereof. By the term natural starch is meant starch which has not been subjected to chemical or physical modification—also known as raw or native starch. The raw starch can be used directly or modified during the process of making the bar composition such that the starch becomes gelatinized, either partially or fully gelatinized.

The adjuvant system may optionally include insoluble particles comprising one or a combination of materials. By insoluble particles is meant materials that are present in solid particulate form and suitable for personal washing. Preferably, there are mineral (e.g., inorganic) or organic particles.

The insoluble particles should not be perceived as scratchy or granular and thus should have a particle size less than 300 microns, more preferably less than 100 microns and most preferably less than 50 microns.

Preferred inorganic particulate material includes talc and calcium carbonate. Talc is a magnesium silicate mineral material, with a sheet silicate structure and a composition of Mg₃Si₄(OH)₂₂, and may be available in the hydrated form. It has a plate-like morphology, and is essentially oleophilic/hydrophobic, i.e., it is wetted by oil rather than water.

Calcium carbonate or chalk exists in three crystal forms: calcite, aragonite and vaterite. The natural morphology of calcite is rhombohedral or cuboidal, acicular or dendritic for aragonite and spheroidal for vaterite.

Examples of other optional insoluble inorganic particulate materials include aluminates, silicates, phosphates, insoluble sulfates, borates and clays (e.g., kaolin, china clay) and their combinations.

Organic particulate materials include: insoluble polysaccharides such as highly crosslinked or insolubilized starch (e.g., by reaction with a hydrophobe such as octyl succinate) and cellulose; synthetic polymers such as various polymer lattices and suspension polymers; insoluble soaps and mixtures thereof.

It is preferred that the compositions of the invention comprise polymers. Polymers of the acrylate class are especially preferred. Preferred bars include 0.05 to 5% acrylates. More preferred bars include 0.01 to 3% acrylates. Examples of acrylate polymers include polymers and copolymers of acrylic acid crosslinked with polyallylsucrose as described in U.S. Pat. No. 2,798,053 which is herein incorporated by reference. Other examples include polyacrylates, acrylate copolymers or alkali swellable emulsion acrylate copolymers, hydrophobically modified alkali swellable copolymers, and crosslinked homopolymers of acrylic acid. Examples of such commercially available polymers are: ACULYN®, CARBOPOL®, and CARBOPOL® Ultrez grade series.

Bar compositions preferably comprise 0.1 to 25% by wt. of bar composition, preferably 5 to 15 by wt. of these mineral or organic particles.

An opacifier may be optionally present in the personal care composition. When opacifiers are present, the cleansing bar is generally opaque. Examples of opacifiers include titanium dioxide, zinc oxide and the like. A particularly preferred opacifier that can be employed when an opaque soap composition is desired is ethylene glycol mono- or di-stearate, for example in the form of a 20% solution in sodium lauryl ether sulphate. An alternative opacifying agent is zinc stearate.

The product can take the form of a water-clear, i.e. transparent soap, in which case it will not contain an opacifier.

The pH of preferred soaps bars of the invention is from 8 to 11, more preferably 9 to 11.

A preferred bar may additionally include up to 30 wt % benefit agents. Preferred benefit agents include moisturizers, emollients, sunscreens and anti-ageing compounds. The agents may be added at an appropriate step during the process of making the bars. Some benefit agents may be introduced as macro domains.

Other optional ingredients like anti-oxidants, perfumes, polymers, chelating agents, colourants, deodorants, dyes, enzymes, foam boosters, germicides, anti-microbials, lathering agents, pearlescers, skin conditioners, stabilizers or superfatting agents, may be added in suitable amounts in the process of the invention. Preferably, the ingredients are added after the saponification step. Sodium metabisulphite, ethylene diamine tetra acetic acid (EDTA), borax or ethylene hydroxy diphosphonic acid (EHDP) are preferably added to the formulation.

The composition of the invention could be used to deliver antimicrobial benefits. Antimicrobial agents that are preferably included to deliver this benefits include oligodynamic metals or compounds thereof. Preferred metals are silver, copper, zinc, gold or aluminium. Silver is particularly preferred. In the ionic form it may exist as a salt or any compound in any applicable oxidation state. Preferred silver compounds are silver oxide, silver nitrate, silver acetate, silver sulfate, silver benzoate, silver salicylate, silver carbonate, silver citrate or silver phosphate, with silver oxide, silver sulfate and silver citrate being of particular interest in one or more embodiments. In at least one preferred embodiment the silver compound is silver oxide. Oligodynamic metal or a compound thereof is preferably included in 0.0001 to 2%, preferably 0.001 to 1% by weight of the composition. Alternately an essential oil antimicrobial active may be included in the composition of the invention. Preferred essential oil actives which may be included are terpineol, thymol, carvacol, (E)-2(prop-1-enyl) phenol, 2-propylphenol, 4-pentylphenol, 4-sec-butylphenol, 2-benzyl phenol, eugenol or combinations thereof. Further more preferred essential oil actives are terpineol, thymol, carvacrol or thymol, most preferred being terpineol or thymol and ideally a combination of the two. Essential oil actives are preferably included in 0.001 to 1%, preferably 0.01 to 0.5% by weight of the composition.

The invention will now be illustrated by means of the following non-limiting examples.

### EXAMPLES

### Example A-C and 1-3: Effect of Soap Bars Outside and within the Invention on Extrudability and Stampability

The following four soap bar compositions as shown in Table-1 were prepared.

TABLE 1

| Ingredient (wt %) | A | B | 1 | 2 | 3 | C |
|---|---|---|---|---|---|---|
| Sodium laurate | 4.6 | 5.9 | 6.8 | 6.8 | 7.3 | 6.8 |
| Sodium palmitate | 33.4 | 43.1 | 50.6 | 49.7 | 50.8 | 50.5 |
| Zeolite 4A | 22.0 | 10.0 | 3.5 | 8.7 | 4.8 | — |
| Sodium chloride | 0.8 | 0.8 | 0.8 | 0.8 | 0.8 | 0.8 |
| Sodium sulphate | 1.2 | 1.2 | 1.2 | 1.2 | 1.2 | 1.2 |
| Sodium citrate | — | — | — | — | 2.0 | — |
| Dihydrate | | | | | | |
| Glycerine | 2.0 | 2.0 | 2.0 | 2.0 | 2.0 | 2.0 |
| Talc | — | — | 8.0 | — | — | 9.0 |
| Minors (perfume, | 1.6 | 1.6 | 1.6 | 1.4 | 1.4 | 1.4 |
| preservative, | | | | | | |
| colour etc) | | | | | | |
| Water | 34.4 | 35.4 | 25.5 | 29.4 | 29.7 | 28.3 |
| Extrudability | Acceptable | Too soft | Good bit | Good | Good | Poor soft |
| | | | soft | | | |
| Stampability | Bar | Sticky; not | Good | Good | Good | Sticky; not |
| | cracks | stampable | | | | stampable |

The data in the above table indicates that compositions within the invention (Examples 1 to 3) are easy to extrude and also stamp. Example A and B are outside the invention and are either difficult to extrude or difficult to stamp or both. When talc is used instead of zeolite (Example C vs. Example 2) the bar produced is sticky and not stampable.

### Example D, 5, 6: Hardness of Bars Prepared with Different Amounts of Zeolite and Magnesium Carbonate

Soaps bars were prepared as in examples of Table-1 above except that different amounts of zeolite and/or magnesium carbonate were used. The formulation of the soap bars are as shown in Table-2 below:

The hardness of the samples were measured using the procedure described below and the measured values are given in Table-2:

### Hardness Testing Protocol

### Principle

A 30° conical probe penetrates into a soap/syndet sample at a specified speed to a pre-determined depth. The resistance generated at the specific depth is recorded. There is no size or weight requirement of the tested sample except that the bar/billet be bigger than the penetration of the cone (15 mm) and have enough area. The recorded resistance number is also related to the yield stress and the stress can be calculated as noted below. The hardness (and/or calculated yield stress) can be measured by a variety of different penetrometer methods. In this invention, as noted above, we use probe which penetrates to depth of 15 mm.

### Apparatus and Equipment

TA-XT Express (Stable Micro Systems)

30° conical probe—Part #P/30c (Stable Micro Systems)

### Sampling Technique

This test can be applied to billets from a plodder, finished bars, or small pieces of soap/syndet (noodles, pellets, or bits). In the case of billets, pieces of a suitable size (9 cm) for the TA-XT can be cut out from a larger sample. In the case of pellets or bits which are too small to be mounted in the TA-XT, the compression fixture is used to form several noodles into a single pastille large enough to be tested.

### Procedure

### Setting Up the TA-XT Express

These settings need to be inserted in the system only once. They are saved and loaded whenever the instrument is turned on again. This ensures settings are constant and that all experimental results are readily reproducible.

### Set Test Method

Press MENU

Select TEST SETTINGS (Press 1)

Select TEST TPE (Press 1)

Choose option 1 (CYCLE TEST) and press OK

Press MENU

Select TEST SETTINGS (Press 1)

Select PARAMETERS (Press 2)

Select PRE TEST SPEED (Press 1)

Type 2 (mm s⁻¹) and press OK

Select TRIGGER FORCE (Press 2)

Type 5 (g) and Press OK

Select TEST SPEED (Press 3)

Type 1 (mm s⁻¹) and press OK

Select RETURN SPEED (Press 4)

Type 10 (mm s⁻¹) and press OK

Select DISTANCE (Press 5)

Type 15 (mm) for soap billets or 3 (mm) for soap pastilles and press OK

Select TIME (Press 6)

Type 1 (CYCLE)

### Calibration

Screw the probe onto the probe carrier.

Press MENU

Select OPTIONS (Press 3)

Select CALIBRATE FORCE (Press 1)—the instrument asks for the user to check whether the calibration platform is clear Press OK to continue and wait until the instrument is ready.

Place the 2 kg calibration weight onto the calibration platform and press OK

Wait until the message “calibration completed” is displayed and remove the weight from the platform.

### Sample Measurements

Place the billet onto the test platform.

Place the probe close to the surface of the billet (without touching it) by pressing the UP or DOWN arrows.

Press RUN

Take the readings (g or kg) at the target distance (Fin).

After the run is performed, the probe returns to its original position.

Remove the sample from the platform and record its temperature.

### Calculation & Expression of Results

### Output

The output from this test is the readout of the TA-XT as “force” (R_{T}) in g or kg at the target penetration distance, combined with the sample temperature measurement. (In the subject invention, the force is measured in Kg at 40° C. at 15 mm distance)

The force reading can be converted to extensional stress, according to the equation below:

The equation to convert the TX-XT readout to extensional stress is

$$σ = \frac{1}{C} \frac{{R}_{T} {g}_{c}}{A}$$

where: σ=extensional stress
   C=“constraint factor” (1.5 for 30° cone)
   G_{c}=acceleration of gravity
   A=projected area of cone=π(d tan ½ θ)²
   d=penetration depth
   θ=cone angle
For a 30° cone at 15 mm penetration Equation 2 becomes

σ(Pa)=R_{T}(g)×128.8
This stress is equivalent to the static yield stress as measured by penetrometer. The extension rate is

$$\dot{ɛ} = \frac{V}{d tan ( \frac{1}{2} θ )}$$

where \tilde{ε}=extension rate (s⁻¹)
   V=cone velocity
For a 30° cone moving at 1 mm/s, ε=0.249 s⁻¹

### Temperature Correction

The hardness (yield stress) of skin cleansing bar formulations is temperature-sensitive. For meaningful comparisons, the reading at the target distance (R_{T}) should be corrected to a standard reference temperature (normally 40° C.), according to the following equation:

R₄₀=R_{T}×exp[α(T−40)]
where R₄₀=reading at the reference temperature (40° C.)
   R_{T}=reading at the temperature T
   α=coefficient for temperature correction
   T=temperature at which the sample was analyzed.

The correction can be applied to the extensional stress.

### Raw and Processed Data

The final result is the temperature-corrected force or stress, but it is advisable to record the instrument reading and the sample temperature also.

A hardness value of at least 1.2 Kg (measured at 40° C.) is acceptable.

TABLE 2

| Ingredient (wt %) | D | 5 | 6 |
|---|---|---|---|
| Sodium laurate | 8.16 | 8.16 | 8.16 |
| Sodium palmitate | 49.29 | 46.89 | 44.30 |
| AOS | 1.00 | 1.00 | 1.00 |
| Magnesium carbonate | 9.0 | 0.00 | 2.00 |
| Zeolite 4A | 0.00 | 9.00 | 7.00 |
| Sodium chloride | 0.70 | 0.70 | 0.70 |
| Tetra sodium | 0.14 | 0.14 | 0.14 |
| etidronate | | | |
| Sodium EDTA and | 0.05 | 0.05 | 0.05 |
| Sodium DTPA | | | |
| Glycerine | 6.0 | 6.0 | 6.0 |
| Colour | 0.11 | 0.11 | 0.11 |
| Perfume | 1.25 | 1.25 | 1.25 |
| Water | 24.3 | 26.7 | 29.3 |
| Hardness (kg) | 2.5 | 2.7 | 2.8 |

The data in the table above confirms that magnesium carbonate may be used to replace a part of the zeolite and good hard bars may still be obtained.

1) An extruded soap bar comprising:
(i) 40 to 75 wt % soap;
(ii) 3 to 20 wt % zeolite; and
(iii) 22 to 35 wt % water.

2) The extruded soap bar as claimed in claim 1, comprising 40 to 60 wt % soap.

3) The extruded soap bar as claimed in claim 1, comprising 5-15 wt % zeolite.

4) The extruded soap bar as claimed in claim 1, comprising 25 to 32 wt % water.

5) The extruded soap bar as claimed in claim 1, additionally comprising 0.1 to 6 wt % of an electrolyte.

6) The extruded soap bar as claimed in claim 5, wherein the electrolyte is not a surfactant and is selected from sodium chloride, sodium sulphate, sodium citrate or a mixture thereof.

7) The extruded soap bar as claimed in claim 1, additionally comprising magnesium carbonate.

8) A process to prepare an extruded soap bar as claimed in claim 1, comprising the step of including substantially all of the zeolite during the step of saponification to form the soap.

9) A process to prepare an extruded soap bar as claimed in claim 5, wherein the electrolyte is included during the step of saponification to form the soap.

10) A process as claimed in claim 1, wherein the extruded soap bar is easy to extrude.

11) The extruded soap bar as claimed in claim 1, wherein the extruded soap bar has a hardness of 1.2 to 5.0 kg at 40° C.
